(19) United States
(12) Patent Application Publication
(10) Pub. No.: US 2022/0025665 A1
(43) Pub. Date: Jan. 27, 2022

(54) Drive-In Motel

(71) Applicant: Kent Eugene Basson, Leesburg, VA (US)

(72) Inventor: Kent Eugene Basson, Leesburg, VA (US)

(21) Appl. No.: 16/937,646

(22) Filed: Jul. 24, 2020

(51) Int. Cl. E04H 3/02; E03D 9/00; B60S 3/04; E04H 6/02

(52) U.S. Cl. CPC E04H 3/02; E04H 6/02; B60S 3/047; E03D 9/002

(57) ABSTRACT

A motel room capable of admitting a car inside may be automatically washed, rinsed, and sanitized in sequential fashion over impermeable wall and floor surfaces, and over bathroom fixtures using one or more headers having nozzles. Wash, rinse, and sanitizing fluids from appropriate reservoirs may be provided in reservoirs fluidly connected to the header and spray nozzles. The header may also be fluidly connected to a source of drying air. The system may also contain a system for recycling water used in the wash, rinse, and sanitizing steps.

### TECHNICAL FIELD

The present invention relates to motel rooms, and more specifically to an automatically cleaned motel room.

### BACKGROUND

The disclosed embodiments relate to a drive in motel in which each room may have a garage door, charging facilities for an electric car, and an automated cleaning system.

The emerging technology of autonomous cars may result in many changes to travel. It is likely that many vehicles will be designed to allow passengers to sleep comfortably. Travelers riding such autonomous cars may opt to travel overnight and sleep on the way, allowing not only travel during less congested times, but also maximizing waking time at a destination. Such decisions could result in decline in demand for traditional hotel/motel rooms. While travelers may be able to comfortably sleep in their cars, they may still need facilities such as toilets, showers, and eating establishments. Many travelers may also be reluctant to use public rest areas late at night.

Electric cars are surging in popularity. Electric cars currently require longer periods to recharge than it takes to refuel cars having internal combustion engines. The combination of passengers' sleeping while traveling, along with more frequent and longer stops, means that a different type of facility than traditional hotels/motels may be needed for travelers.

Still another major factor in today's economy is the aftermath of the worldwide panic over the COVID-19 virus. Many people are now more likely to try to avoid contact with others in public places and through spaces sequentially and/or simultaneously occupied by others such as public restrooms and hotel rooms.

One possible new type of facility to solve the above combination of problems is proposed by the present embodiment. The embodiment may comprise a drive-in motel room that may have minimal facilities such as a shower and toilet, and that may allow charging of an electric car. Rather than a traditional nightly rate, such a room may have hourly rates. The room may also have an automated cleaning system that may quickly prepare the room for the next occupant while also reducing labor costs for cleaning and restocking.

### SUMMARY OF THE EMBODIMENTS

Motel rooms of some embodiments may have a conventional roll-up garage door allowing guests to drive their cars into the rooms. The motel may be almost fully automated, allowing a guest to make reservations, pay, enter the room, and check out using a smart phone or other mobile device. The room may include a charging station for an electric car. The amenities may be very basic, only including facilities such as a toilet and shower, with flooring and all other surfaces being impermeable to water and oil to allow automated cleaning between guests.

Stops for recharging an electric car may provide time for a quick shower and taking care of necessary bodily functions. With most stops anticipated to be relatively short for autonomous cars, especially those with sleeping facilities, rooms of some embodiments may be used several times per day.

The drive in feature may provide for greater guest comfort than current motel rooms as there may be no need for exposure of guests to possibly adverse weather conditions in order to enter the room. If an overnight or longer stay is desired, a guest's luggage may be readily available in the car instead of having to be carried inside.

While it is anticipated that most guests will not need sleeping facilities to be provided in the room, it is possible to provide one or more foldout beds of water impermeable material, which may still allow automated cleaning to be used. If desired, guests may use their own sleeping bags or other bed clothes to sleep on the bed.

Bedbugs have become a major problem in hotels and motels, and the impermeable surfaces and automated cleaning of the disclosed embodiments may drastically reduce the opportunities for infestation by bedbugs and other pests.

The cleaning system may comprise spray nozzles that sequentially spray water and detergent to drive any debris toward a floor drain, a disinfectant to kill germs, and air (which may be heated) to dry the room.

The room may have cabinets or storage bins for both fresh and used towels. Inventory systems using RFIDs or other remotely detectable identification methods may be used to keep track of towels used by guests. The cabinets or storage bins may be accessed from outside the room to allow fresh towels to be made available to guests and collect used towels without motel employees' entering the room. A lip may be placed above and around the cavity containing a bin in order to prevent water from entering the bin during automated cleaning of the room.

As an alternative to providing towels, after shower and hand drying systems may be provided that supply heated air.

The above features mean that not only may less labor be required to maintain rooms, but there may also be less contact between guests and employees, as well as between the guests themselves, reducing the chances of spreading disease.

### BRIEF DESCRIPTION OF THE DRAWINGS

FIG. 1 is a plan view of a drive-in motel room.

FIG. 2 is a diagram of an embodiment of a cleaning and disinfecting system.

FIG. 3 is a diagram of an embodiment of a cleaning, disinfecting, and drying system.

FIG. 4 is a diagram of an embodiment of a cleaning, disinfecting, and drying system.

FIG. 5 is a diagram of a cleaning, disinfecting, drying, and water recycling system.

### DETAILED DESCRIPTION OF SPECIFIC EMBODIMENTS

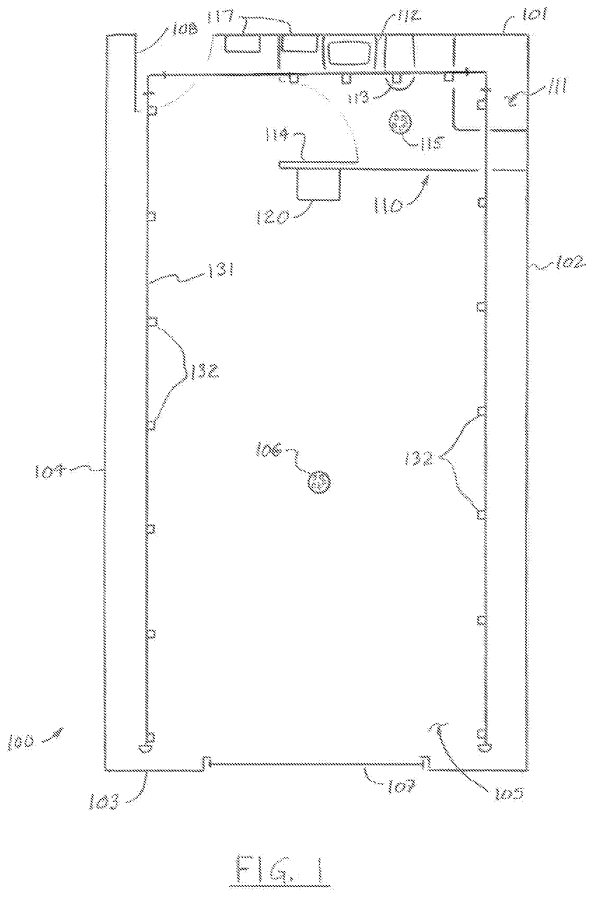

Referring to FIG. 1, room 100 may be an enclosure having enclosure walls 101, 102, 103, 104, graded floor 105, and a ceiling (not shown). Enclosure walls 101-104 and the ceiling may be made of a material impermeable to water and oil, or coated with such a material. Similarly, graded floor 105 may be of concrete coated with a material impermeable to water and oil such as epoxy. Room 100 may be freestanding or, preferably, one of a plurality of such rooms forming a motel. Room 100 may have a floor drain 106 over which a car may be parked when room 100 is occupied. Fold-down tables and chairs (not shown), preferably made of a material impermeable to water, may be mounted on walls for the use of guests. While it is anticipated that guests will normally rest and sleep in their vehicle, fold-down beds (not shown) of a water-impermeable material may be provided.

Garage door 107 may be a conventional overhead garage door and may be provided with an enhanced door sealing system, e.g., as disclosed in U.S. Pat. No. 8,869,868 to Schmidt (“Schmidt '868”), which is incorporated by reference herein. Garage door 107 may allow automobiles to enter room 100.

Walk-in door 108 may be provided to allow guests of the motel to exit room 100 to enter a common hallway or outdoors. The hallway may provide access to other such rooms, conventional motel rooms in the same motel, common areas, restaurants, or other conveniences.

A bathroom 110 may be provided in room 100 with a shower 111, sink 112, toilet 113, and bathroom door 114. The sides of sink 112 and toilet 113 may extend vertically to the floor to avoid surfaces that would not be easily cleaned and disinfected from above. A bathroom floor drain 115 may be provided at a low point of bathroom 110. Alternatively, the walls of bathroom 110 may have gaps at the bottom to allow water to flow by gravity to floor drain 106. Bathroom 110 may further be provided with a first cabinet (not shown) in which towels, floor mats, and washcloths may be stored. Trash disposal containers 117 may be provided inside and outside bathroom 110. The first cabinet and and trash disposal containers 117 may be accessible from outside room 100 and bathroom 110 such that entry by motel personnel is not ordinarily required. The first cabinet and trash disposal containers 117 may be provided with watertight doors or lips around doors to prevent water entry into trash disposal containers 117 and/or the first cabinet on the side facing inside room 100. The first cabinet may use a towel tracking system similar to that disclosed in U.S. Pat. No. 8,362,878 to Molewyk et al. (“Molewyk '878”), incorporated herein by reference. The first cabinet may include both an area for clean towels and such, and also an area into which used towels and such may be deposited. To encourage guests to return towels and washcloths to the cabinet for cleaning, thus making entry by motel personnel unnecessary for the purpose, guests may be charged for towels unaccounted for because they are neither in the clean nor used portions of the first cabinet. As an alternative, or supplement, to towels provided in the cabinet, an after shower body dryer as described in U.S. Pat. No. 3,128,161 to Hudon (“Hudon '161”), the contents of which are incorporated herein by reference, may be provided in bathroom 110. A wall-mounted hand dryer (not shown) may also be provided for use after washing hands.

A second cabinet (not shown) accessible both from inside and outside room 100 may be provided to allow food and other materials to be delivered to room 100 without face-to-face contact between delivery personnel and guests within room 100. The door of the second cabinet facing inside room 100 may be watertight when closed as described above with reference to the first cabinet and trash disposal containers 117.

Modern automobiles are often equipped with multiple entertainment options, including Internet access and headrest mounted and/or drop-down video systems. Such options will only become more numerous and common as autonomous cars are adopted and the cost of such systems is further reduced. As a result, there is little need for such entertainment options to be reproduced in a drive-in motel room as guests may use the options available in their vehicle. However, if a larger screen is desired, such rooms may be provided with television screens (not shown) mounted in the walls behind a waterproof barrier. Seating (not shown) of water impermeable material with low spots for drainage may also be provided, along with work tables (not shown) of water impermeable materials.

Considering the increasing popularity of electric and plug-in hybrid cars, room 100 may include an automatic recharging docking station 120 for such vehicles such as disclosed in US Patent Application Publication 2007/0126395A1 to Suchar (“Suchar '395”), the contents of which are incorporated herein by reference. Alternatively, docking station 120 may be a manually connected charging station or another automatic system for recharging an electric vehicle.

In order to minimize motel labor and also reduce the chances of disease transmission, an automated cleaning system may be provided. Spray header 131 may be provided to sequentially provide water, disinfectant, and air to clean and dry room 100 and bathroom 110 through spray nozzles 132. While a single header 131 is shown in FIG. 1, multiple headers 131 may be provided to ensure adequate coverage of spray from spray nozzles 132. Air provided for drying may be heated to expedite drying. Spray nozzles 132 may either be stationary to reduce installed and maintenance costs, or may rotate or reciprocate in order to provide greater coverage, and may incorporate elements of U.S. Pat. No. 3,742,520 to Bernardi, the contents of which are incorporated herein by reference. Water entering drains 106 and 115 may be recycled using the system disclosed in U.S. Pat. No. 5,374,352 to Pattee (“Pattee '352”), the contents of which are incorporated herein by reference.

To provide access to room 100 using a mobile device, a system similar to that disclosed in U.S. Pat. No. 9,361,741 to Robertson et al. (“Robertson '741”), the contents of which are incorporated herein by reference, may be provided. This system may allow guests to enter room 100 without directly interacting with motel employees to obtain keys and such.

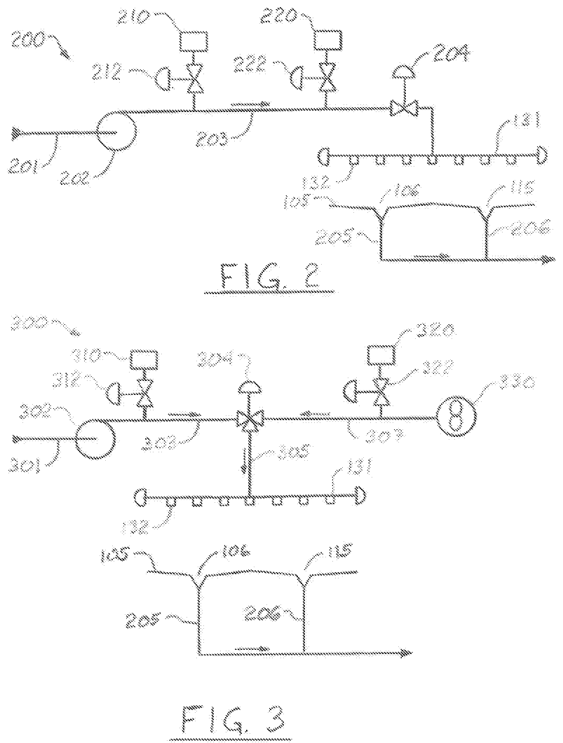

Referring to FIG. 2, a first embodiment is shown which may include a simple cleaning and disinfecting system 200 that may be appropriate for a motel with relatively few rooms. Conduit 201 may allow water to flow from a water source to water pump 202. The water source may be a well, municipal water supply, or any other source of relatively clean water. Depending on the pressure of the water source, water pump 202 may be omitted. Water may be discharged from water pump 202 into conduit 203, and from conduit 203 to header 131, from which water may be sprayed through spray nozzles 132. Water control valve 204 may be included in conduit 203 for controlling pressure at spray nozzles 132 , preventing water flow due to pressure from the water source through water pump 202 when it is not running, and/or preventing water flow to header 131 in the event that one or more other rooms is being cleaned while room 100 is either occupied or already cleaned and waiting for the next occupant(s).

As explained above, water falling onto graded floor 105 may flow by gravity to floor drain 106 and, if included, bathroom floor drain 115. Water from floor drain 106 and, if included, bathroom floor drain 115 may flow by gravity through drain conduits 205 and 206 to an appropriate receptacle, water treatment facility, or municipal sewage system, e.g.

In order to provide detergent for a cleaning step, detergent reservoir 210 may be provided, with detergent control valve 212 providing the ability to control flow of detergent to conduit 203 during a cleaning step. Flow of detergent from detergent reservoir 210 to conduit 203 may be induced by a detergent pump (not shown), gravity, pressurization, or the Venturi effect of water flowing through conduit 203.

In order to provide disinfectant for a disinfecting step, disinfectant reservoir 220 may be provided, with disinfectant control valve 222 providing the ability to control flow of disinfectant to conduit during a disinfecting step. As described above with respect to detergent, flow of disinfectant from disinfectant reservoir 220 to conduit 203 may be induced by a disinfectant pump (not shown), gravity, pressurization, or the Venturi effect of water flowing through conduit 203.

The first embodiment shown in FIG. 2 may include a cleaning step in which detergent is added from detergent reservoir 210 to water flowing through conduit 203, a rinsing step in which water flows through conduit 203 with no detergent or disinfectant added, and a disinfecting step in which disinfectant is added from disinfectant reservoir 220 to water flowing through conduit 203. In this embodiment, graded floor 105 may be dried of moisture from any of the cleaning step, rinsing step, and disinfecting step by draining to floor drain 106 and, possibly, bathroom floor drain 115; and evaporation of the moisture.

More than one room may be cleaned and disinfected by providing one or more branches (not shown) from conduit 203 downstream of disinfectant control valve 222 and upstream of water control valve 204, with the branch including all elements shown downstream of disinfectant control valve 222. Each branch may include a water control valve analogous to water control valve 204 in order to allow one room at a time to be cleaned and disinfected.

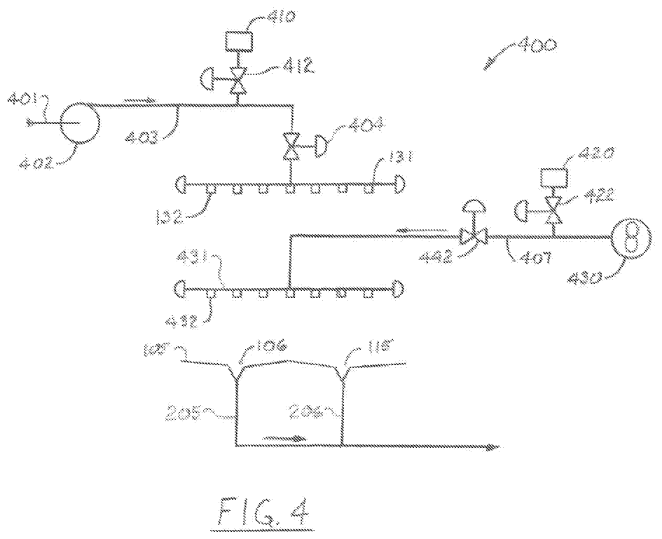

Referring to FIG. 3, a second embodiment is shown which may include a cleaning, disinfecting, and drying system 300 that may also be appropriate for a motel with relatively few rooms, but which may provide a further drying step that may allow rooms to be used with a shorter interval between users. Conduit 301 may allow water to flow from a water source to water pump 302. The water source may be a well, a municipal water supply, or any other source of relatively clean water. Depending on the pressure of the water source, water pump 302 may be omitted. Water may be discharged from water pump 302 into conduit 303, and from conduit 303 through three-way valve 304 to conduit 305 to header 131, from which water may be sprayed through spray nozzles 132.

As explained above, water falling onto graded floor 105 may flow through gravity to floor drain 106 and, if included, bathroom floor drain 115. Water from floor drain 106 and, if included, bathroom floor drain 115 may flow by gravity through drain conduits 205 and 206 to an appropriate receptacle, water treatment facility, or municipal sewage system, e.g.

In order to provide detergent for a cleaning step, detergent reservoir 310 may be provided, with detergent control valve 312 providing the ability to control flow of detergent to conduit 303 during a cleaning step. Flow of detergent into conduit 303 may be induced by a detergent pump (not shown), gravity, pressurization, or the Venturi effect of water flowing through conduit 303.

Three-way valve 304 may have three positions: (1) a first closed position in which no flow is admitted to conduit 305, (2) a second position in which water flows from conduit 303 to conduit 305, and (3) a third position in which air from air blower 330 flows from conduit 307 and then into conduit 305. Air blower 330, which may be a blower or a compressor, may provide air for a drying step in which air from air blower 330 flows through conduit 307, three-way valve 304, conduit 305, and header 131 to be discharged through spray nozzles 132. Air blower 330 may provide air for a disinfecting step in which disinfectant is introduced from disinfectant reservoir 320 through disinfectant control valve 322 into air flow through conduit 307, and sequentially through three-way valve 304, conduit 305, and header 131 to be discharged through spray nozzles 132. Flow of disinfectant from disinfectant reservoir 320 to conduit 307 may be induced by a pump (not shown), gravity, pressurization, or the Venturi effect of water flowing through conduit 307. While disinfectant may alternatively be introduced into the water flow through conduit 303, introducing it into the air flow through conduit 307 may allow a reduction in disinfectant consumption because less disinfectant may be carried to the drain with the water. It may also be possible to combine the drying and disinfecting steps in order to save time.

Conduits 303 and 307 may each have one or more branches (not shown) downstream of detergent control valve 312 and disinfectant control valve 322, respectively, with each branch going to a valve analogous to three-way valve 304 for each room in the motel such that each room can be individually cleaned, disinfected, and dried.

The second embodiment shown in FIG. 3 may include a cleaning step in which detergent is added from detergent reservoir 310 to water flowing through conduit 303 with three-way control valve 304 in the second position, a rinsing step in which water flows through conduit 303 with no detergent added with three-way control valve 304 in the second position, a disinfecting step in which disinfectant is added from disinfectant reservoir 320 to air flowing through conduit 307 with three-way control valve 304 in the third position, and a drying step in which air flows through conduit 307 without the addition of disinfectant. Although not required, drying air may be heated to speed drying, which may also assist in disinfection.

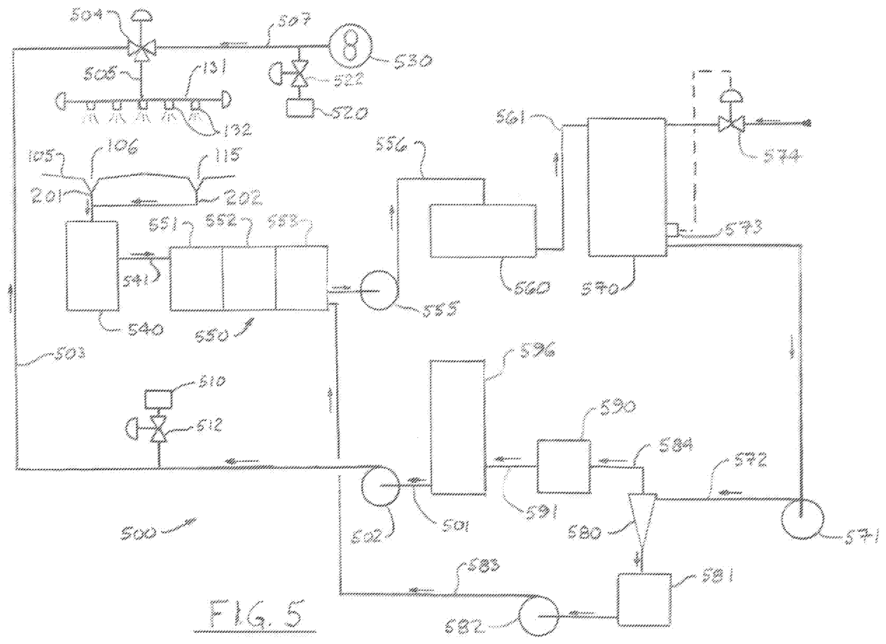

Referring to FIG. 4, a third embodiment is shown which may include a cleaning, disinfecting, and drying system 400 that may also be appropriate for a motel with relatively few rooms. The third embodiment may be similar to the second embodiment except that it may have a separate header for drying air. Conduit 401 may allow water to flow from a water source to water pump 402. The water source may be a well, a municipal water supply, or any other source of relatively clean water. Depending on the pressure of the water source, water pump 402 may be omitted. Water may be discharged from water pump 402 into conduit 403, and from conduit 403 to header 131, from which water may be sprayed through spray nozzles 132. Water control valve 404 may be included in conduit 403 for controlling pressure at spray nozzles 132, preventing water flow due to pressure from the water source through water pump 402 when it is not running, and/or preventing water flow to header 131 in the event that one or more other rooms are being cleaned while room 100 is either occupied or already cleaned and waiting for the next occupant(s).

As explained above, water falling onto graded floor 105 may flow by gravity to floor drain 106 and, if included, bathroom floor drain 115. Water from floor drain 106 and, if included, bathroom floor drain 115 may flow by gravity through drain conduits 205 and 206 to an appropriate receptacle, water treatment facility, or municipal sewage system, e.g.

In order to provide detergent for a cleaning step, detergent reservoir 410 may be provided, with detergent control valve 412 providing the ability to control flow of detergent to conduit 403 during a cleaning step. Flow of detergent from detergent reservoir 410 to conduit 403 may be induced by a detergent pump (not shown), pressurization, or the Venturi effect of water flowing through conduit 403.

More than one room may be cleaned by providing one or more branches (not shown) from conduit 403 downstream of detergent control valve 412 and upstream of water control valve 404, with the branch including all elements shown downstream of detergent control valve 412. Each branch may include a water control valve analogous to water control valve 404 in order to allow one room at a time to be cleaned and disinfected.

Air blower 430, which may be either a blower or air compressor, may provide air for a drying step in which air from air blower 430 flows through conduit 407 into air header 431 to be discharged through air spray nozzles 432. Air header 431 may be arranged parallel to spray header 132 or in any other location such that it provides effective drying of graded floor 105 through air flowing from air spray nozzles 432. Air spray nozzles 432 may either be stationary to reduce installation and maintenance costs, or may rotate or reciprocate in order to provide greater coverage, and may incorporate elements of Bernardi '520, the contents of which are incorporated herein by reference. Air blower 430 may provide air for a disinfecting step in which disinfectant is introduced from disinfectant reservoir 420 through disinfectant control valve 422 into air flow through conduit 407 to be discharged through spray nozzles 432. Flow of disinfectant from detergent reservoir 410 to conduit 407 may be induced by a pump (not shown), gravity, pressurization, or the Venturi effect of water flowing through conduit 407. While disinfectant may alternatively be introduced into the water flow through conduit 403, introducing it into the air flow through conduit 407 may allow a reduction in disinfectant consumption because less disinfectant may be carried to the drain with the water. It may also be possible to combine the drying and disinfecting steps in order to save time.

Air control valve 442 may be provided in conduit 407 to allow header 431 to be isolated when air blower 430 is operating to provide drying/disinfecting air to a different room supplied by air in one or more branches (not shown) from conduit 407 downstream of disinfectant control valve 422 and upstream of air control valve 442 with the branch(es) containing analogous elements to those shown downstream of disinfectant control valve 422.

The third embodiment shown in FIG. 4 may include a cleaning step in which detergent is added from detergent reservoir 410 to water flowing through conduit 403, a rinsing step in which water flows through conduit 403 with no detergent added, a disinfecting step in which disinfectant is added from disinfectant reservoir 420 to air flowing through conduit 407, and a drying step in which air flows through conduit 407 without the addition of disinfectant. Alternatively, the drying and disinfecting step can be combined, with disinfectant from disinfectant reservoir 420 being added to air in conduit 407 during the drying step. Although not required, drying air may be heated to speed drying, which may also assist in disinfection.

Referring to FIG. 5, a fourth embodiment that may include a cleaning and water recycling system 500 is shown. With a large number of rooms, it may be anticipated that the cleaning system will recycle water due to the large volumes used in cleaning as well as possibly to meet emissions standards. Cleaning and water recycling system 500 may include features disclosed in Pattee '352 and Bernardi '520, the contents of both of which are incorporated herein by reference. While the embodiment is not limited to the recycling system of The following description of the fourth embodiment may include a summary of the process of Pattee '352, with the details of various components to be found within the description of Pattee '352.

Conduit 501 may allow water flow to water pump 502, which pumps water through conduit 503 to three-way control valve 504, conduit 505, and header 131, from which water may be sprayed through spray nozzles 132. Three-way control valve 504 may be included for preventing water flow through water pump 502 when it is not running due to pressure from the water source and/or preventing water flow to header 131 in the event that one or more other rooms is being cleaned while room 100 is either occupied or already cleaned and waiting for the next occupant(s).

In order to provide detergent for a cleaning step, detergent reservoir 510 may be provided, with detergent control valve 512 providing the ability to control flow of detergent to conduit 503 during a cleaning step. Flow of detergent may be induced by a detergent pump (not shown), pressurization, or the Venturi effect of water flowing through conduit 503.

Three-way valve 504 may have three positions: (1) a first closed position in which no flow is admitted to conduit 505, (2) a second position in which water flows from conduit 503 to conduit 505, and (3) a third position in which air from air blower 530 flows from conduit 507 and then into conduit 505. Air blower 530, which may be a blower or an air compressor, may provide air for a drying step in which air from air blower 530 flows through conduit 507, three-way valve 504, conduit 505, and header 131 to be discharged through spray nozzles 132. Air blower 530 may provide air for a disinfecting step in which disinfectant is introduced from disinfectant reservoir 520 through disinfectant control valve 522 into air flow through conduit 507, and sequentially through three-way valve 504, conduit 505, and header 131 to be discharged through spray nozzles 132. While disinfectant may alternatively be introduced into the water flow through conduit 503, introducing it into the air flow through conduit 507 may allow a reduction in disinfectant consumption because less disinfectant may be carried to the drain with the water. It may also be possible to combine the drying and disinfecting steps in order to save time. Although not required, drying air may be heated to speed drying, which may also assist in disinfection.

Conduits 503 and 507 may each have one or more branches (not shown) downstream of detergent control valve 512 and disinfectant control valve 522, respectively, with each branch going to a valve analogous to three-way valve 504 for each room in the motel such that each room can be individually cleaned, disinfected, and dried.

Except for the small amounts lost to evaporation and that land in shower 111, sink 112, and toilet 113, water from spray headers 131 and spray nozzles 132 may land on graded floor 105 and flow to floor drain 106 and bathroom floor drain 115 through floor grates, from which drains they may travel in conduits 201 and 202, respectively, to collection tank 540. Collection tank 540 may collect larger solid debris for periodic removal by a waste disposal company.

Water mixed with contaminants may be transferred through conduit 541 to separator 550. Separator 550 may comprise a settling tank 551, trap tank 552, and pump tank 553. While shown in FIG. 5 as a unitary tank with internal walls, settling tank 551, trap tank 552, and pump tank 553 may be separate tanks connected sequentially by conduits. Solid matter may settle at the bottom of settling tank 551 for ultimate removal by a waste disposal company. Trap tank 552 may use differences in specific gravity to separate oily and soapy residue from the water before it is transferred to pump tank 553, which may provide the required net positive suction head to allow pump 555 to transfer the water through conduit 556 to sand filter tank 560. Solid matter from settling tank 551 and oily and soapy residue from trap tank 552 may be periodically removed by a waste disposal company.

Sand filter tank 560 may contain layers of river gravel, sand, and smooth river stone to remove remaining suspended solids, trace oil, etc. by vertical gravity flow. From sand filter tank 560, the further purified water may be conducted either by gravity or a pump (not shown) through conduit 561 to balance tank 570, which may provide the net positive suction head to allow pump 571 to pump the wash water through conduit 572 to cyclone separator 580. Low water level detector 573, which may be a float switch, may detect when the water level in balance tank 570 is too low to provide adequate net positive suction head for pump 571, and may provide a signal to make-up water valve 574 to open and allow flow of make-up water (presumably, but not necessarily, from a municipal water supply) to balance tank 570. Depending on the type of detector low water level detector 573 is chosen to be, it may also provide a signal to close make-up water valve 574. Alternatively, if low water level detector 573 is chosen to be a float valve, a second float valve (not shown) placed at a higher level in balance tank 570 may provide a signal to close make-up water valve 574.

Captured solids may be discharged out the bottom of cyclone separator 580 along with a portion of the water entering cyclone separator to sludge cart 581, from which the water and captured solids may be pumped by pump 582 to pump tank 553 of separator 550 through conduit 583. Further clarified water may be discharged from the top of cyclone separator 580 to carbon filter 590 through conduit 584. From carbon filter 590, clean water may go through conduit 591 to clean water tank 596, where it provides water to conduit 501 and water pump 502, completing the loop.

While a single spray header 131 is shown in FIG. 1, it is anticipated that a motel of the disclosed embodiments would have multiple rooms 100, with each room 100 having its own spray header 131 or set of spray headers 131 for that room 100 with associated valves to control flow of water and air to each room.

It is further anticipated that all pumps and blowers may have identical pumps in parallel in order to provide additional flow when multiple rooms are being cleaned simultaneously.

The water recycling system disclosed above is only exemplary. It will be clear to those of skill in the art that there are numerous other ways to accomplish the same end, and that other more efficient methods may be found in the future. Thus, the present embodiments are not limited to such a water recycling system. It should also be noted that tanks in the recycling system may be above ground and/or underground. The particular arrangement of the tanks may allow gravity flow or necessitate pumps between various tanks.

Safety features may be included to prevent the cleaning cycle from being initiated if room 100 is occupied. For example, a vehicle detection system similar to that disclosed in US Patent Application Publication No. 2002/0190856 A1 to Howard (“Howard '856”) (not shown), the disclosure of which is herein incorporated by reference, may be installed in floor 105 near drain 106. The vehicle detection system may provide an interlock keeping valves locked in position to prevent flow of water, detergent, air, and disinfectant while a car is located within room 100. The vehicle detection system may further be used in determining when a vehicle leaves room 100 for hourly billing purposes. The system disclosed in Howard '856 is mentioned for exemplary purposes only and other systems capable of detecting the presence of vehicles may be used for the same purposes.

An alternate, or additional, measure to ensure that room 100 is unoccupied before the cleaning cycle is initiated may include a system for detecting human presence such as disclosed in U.S. Pat. No. 7,985,953 to Luterotti et al. (“Luterotti '953”), the disclosure of which is herein incorporated by reference. This system is exemplary only and may be combined with the vehicle detection system described above to prevent flow of water, detergent, air, and disinfectant until neither a vehicle nor a human is detected within room 100.

Cameras may also be mounted within room 100 to allow remote visual inspection to determine whether debris that requires removal prior to the cleaning cycle is present.

While the disclosed embodiments were conceived with autonomous cars in mind, they are not limited to use by such vehicles. While room 100 may have a charger for electric vehicles, room 100 may also be used by internal combustion engine and hybrid cars, or cars with other power sources. The foregoing description of the embodiments is intended to be illustrative and non-limiting. Many changes and modifications are possible in light of the above teachings. Thus, it is understood that the embodiments may be practiced otherwise than as specifically described herein and still be within the scope of the appended claims.

### ELEMENT REFERENCE NUMBERS

100—room
101-104—enclosure walls
105—graded floor
106 —floor drain
107—garage door
108—walk-in door
110—bathroom
111—shower
112—sink
113—toilet
114—bathroom door
115—bathroom floor drain
117—trash disposal containers
120—recharging docking station
131—spray headers
132—spray nozzles
200—cleaning and disinfecting system
201—conduit
202—water pump
203—conduit
204—water control valve
205—drain conduit
206—drain conduit
210—detergent reservoir
212—detergent control valve
220—disinfectant reservoir
222—disinfectant control valve
300—cleaning, disinfecting, and drying system
301—conduit
302—water pump
303—conduit
304—three-way control valve
305—conduit
307—conduit
310—detergent reservoir
312—detergent control valve
320—disinfectant reservoir
322—disinfectant control valve
330—air blower
400—cleaning, disinfecting, and drying system
401—conduit
402—water pump
403—conduit
404—water control valve
407—conduit
410—detergent reservoir
412—detergent control valve
420—disinfectant reservoir
422—disinfectant control valve
430—air blower
431—air header
432—air spray nozzles
442—air control valve
500—cleaning and water recycling system
501—conduit
502—water pump
503—conduit
504—three-way control valve
505—conduit
507—conduit
510—detergent reservoir
512—detergent control valve
520—disinfectant reservoir
522—disinfectant control valve
530—air blower
540—collection tank
541—conduit
550—separator
551—settling tank
552—trap tank
553—pump tank
555—pump
556—conduit
560—sand filter tank
561—conduit
570—balance tank
571—pump
572—conduit
573—low water level detector
574—make-up water valve
580—cyclone separator
581—sludge cart
582—pump
583—conduit
584—conduit
590—carbon filter
591—conduit
596—clean water tank

I claim:

1. A drive-in motel room comprising:
an enclosure of water impermeable material;
a sub-enclosure of water impermeable material, the sub-enclosure enclosing:
a shower;
a toilet; and
a sink;
a door capable of opening to allow a vehicle to enter the enclosure; and
a system for automatically cleaning the enclosure and sub-enclosure, the system comprising:
a first piping network secured to the enclosure, and having an inlet and a plurality of outlets;
a plurality of spray nozzles associated with the plurality of outlets;
a floor drain;
a source of water selectively connected to the first piping network; and
a source of detergent selectively connected to the first piping network.

2. The drive-in motel room of claim 1, further comprising a source of air selectively connected to the first piping network.

3. The drive-in motel room of claim 1, further comprising:
a second piping network; and
a source of air connected to the second piping network.

4. The drive-in motel room of claim 1, further comprising a source of disinfectant selectively connected to the first piping network.

5. The drive-in motel room of claim 3, further comprising a source of disinfectant selectively connected to the second piping network.

6. The drive-in motel room of claim 1, further comprising a charging system for electric vehicles.

7. The drive-in motel room of claim 1, further comprising a system for recycling water from the floor drain for reuse in the system for automatically cleaning the enclosure and sub-enclosure.

8. The drive-in motel room of claim 1, further comprising an after-shower body dryer.

9. The drive-in motel room of claim 1, further comprising a storage area accessible from both inside the drive-in motel room and outside the drive-in motel room.

10. The drive-in motel room of claim 1, further comprising an element for detecting the presence of a vehicle or a person within the drive-in motel room.

11. A method of cleaning and disinfecting a drive-in motel room having enclosure walls of water-impermeable material and a floor of water-impermeable material, the method comprising the following steps:
spraying water and a detergent from a first permanently installed piping network onto the enclosure walls and the floor;
rinsing the detergent from the enclosure walls and floor with water from the first permanently installed piping network; and
spraying disinfectant onto the enclosure walls and the floor.

12. The method of claim 11, comprising the additional step of drying the enclosure walls and floor by spraying air onto the enclosure walls and the floor.

13. The method of claim 12, wherein the air sprayed onto the enclosure walls and the floor is supplied through the first permanently installed piping network.

14. The method of claim 12, wherein the air sprayed onto the enclosure walls and the floor is supplied through a second permanently installed piping network.

15. The method of claim 11, comprising the additional step of draining water and detergent from the floor and recycling the water and detergent through a system that removes debris and detergent from the drained water.

16. A system for cleaning water-impermeable surfaces of a drive-in motel room including bathing facilities, the system comprising:
a piping network secured to the enclosure, and having an inlet and a plurality of outlets;
a plurality of spray nozzles associated with the plurality of outlets;
a floor drain;
a source of water selectively connected to the piping network; and
a source of detergent selectively connected to the piping network.

17. The system of claim 16, further comprising a source of compressed air for drying the drive-in motel room.

18. The system of claim 16, further comprising a source of disinfectant selectively connected to the piping network.

19. The system of claim 17, further comprising a source of disinfectant selectively connected to the source of compressed air for drying the drive-in motel room.

20. The system of claim 16, further comprising a system for cleaning and recycling water from the source of water.
